(19) United States
(12) Patent Application Publication
(10) Pub. No.: US 2006/0147859 A1
(43) Pub. Date: Jul. 6, 2006

(54) Post-combustion device

(76) Inventors: Guenter Hoenig, Ditzingen (DE); Frank Miller, Ilsfeld (DE)

Correspondence Address: KENYON & KENYON LLP, ONE BROADWAY, NEW YORK, NY, 10004, US

(21) Appl. No.: 10/530,319

(22) PCT Filed: Sep. 3, 2003
(86) PCT No.: PCT/DE03/02917

§ 371 Date: Nov. 5, 2005

(30) Foreign Application Priority Data
Oct. 4, 2002 (DE) 102 46 231.3

(51) Int. Cl. F21V 35/00; B01J 35/02

(52) U.S. Cl. 431/156; 126/263.02; 422/222

(57) ABSTRACT

An afterburner, in particular for chemical reformers intended to procure hydrogen, for afterburning residual gases from a reforming and/or fuel cell process has at least one nozzle for metering fuel and combustible residual gases into a combustion chamber and at least one air supply. The combustion chamber is at least partially filled with a heat-resistant, open-pore ceramic foam.

### FIELD OF THE INVENTION

The present invention is directed to an afterburner.

### BACKGROUND INFORMATION

In fuel cell-based transport systems, chemical reformers are used to procure the requisite hydrogen from hydrocarbon fuels.

The optimum operating temperature of a chemical reformer is normally far higher than its ambient temperature. This gives rise to problems, in particular in the case of passenger vehicles. Because the vehicle is so frequently stationary, there are a large number of cold starts, during which the chemical reformer, in particular, does not function optimally. At very low load, the reformer may also not reach the optimum operating temperature as a result of the heat occurring therein, or may drop below that temperature during operation.

In particular in the case of fuel cell-based propulsion systems having chemical reformers, it is consequently advantageous to utilize afterburners, which, in particular, have the function of converting combustible residual gases or exhaust gases, for example from a fuel cell process, into heat and reducing emissions by preventing uncontrolled discharge of those gases into the environment. The heat generated is supplied, for example, to a reformer or fuel cell, in order to bring it rapidly to operating temperature, thus shortening the cold-start phase. In addition, the heat generated is used to maintain the required operating temperature of the reformer and the fuel cells. Thus, the optimum operating temperature is maintained, even under partial-load conditions.

The afterburner burns up the combustible residual gases, for example residual hydrogen from a fuel cell or residual gases from a catalytic combustor, either with a flame or in some cases partially catalytically. Additionally, there is thermal transfer from the afterburner to the chemical reformer, but the heat from the combustible residual gases is not normally sufficient on its own to provide a sufficiently high thermal output. As a result, fuel is normally metered into the afterburner, either on its own or as an addition. The fuel, which is preferably in liquid form, is broken up into a cloud of droplets having as small a diameter as possible, by means of complex and highly unreliable devices, and is injected into a combustion chamber. The minimal droplet diameter (Sauter diameter) is needed in order to bring the greatest possible fuel surface area in contact with oxygen and heat, and thus to make the combustion process as complete as possible.

A disadvantage of this approach is that the metering devices for creating a cloud of small-diameter droplets are very complex, expensive, and unreliable. The required low droplet diameter can often be achieved only by application of a high fuel pressure, the generation of this high pressure demanding relatively high amounts of power and in particular, the system for generating such pressure requiring a large amount of space. In addition, such metering devices normally have very small metering orifices, which affect the metering behavior of the metering device in an unreliably and poorly controllable manner as a result of combustion residues or deposits. Because of the high temperatures occurring in the combustion chamber, the metering device needs to be located apart from the combustion chamber and is thus not able to meter the fuel directly into the combustion chamber. This makes it necessary to have a metering pipe to transport the fuel from the metering device to the combustion chamber, but it is possible for the fuel contained therein, for example while the vehicle is stationary, to evaporate and thus escape without control. This results, among other things, in high uncontrolled emission of pollutants. As an alternative to or in support of the use of high fuel pressure, solutions are known that use air to assist in the fine atomization of the fuel, the fuel or residual gas being swirled before combustion by air for a sufficiently long period. Here, the disadvantage is the relatively large amount of space required, the complex and unreliable regulation of the metering of the air, and the additional amount of power required.

Finally, in particular at low power there is the danger that the open and continuously burning flame in the combustion chamber will be unexpectedly extinguished. The thermal output of the afterburner is greatly reduced as a result. Furthermore, a certain amount of time is always required in order to shut off the supply of fuel or to re-ignite the flame, during which time fuel or residual gas may accumulate in the combustion chamber. This has a negative impact on re-ignition, since a catalytic converter—if installed—may be damaged and unburned fuel or residual gas may escape into the atmosphere. Despite all the measures listed, unburned or incompletely burned portions remain in the exhaust of the afterburner, some of these being toxic or chemically aggressive. This results in an increased strain on the environment as well as on the material, and in addition, the calorific value of the fuel or residual gas is utilized only incompletely.

### SUMMARY OF THE INVENTION

In contrast, the afterburner according to the present invention has the advantage that the metering of fuel onto or into the heat-resistant open-pore ceramic foam results in very good distribution of fuel in the combustion chamber or in the ceramic foam, without the use of complex atomization devices to create extremely small fuel droplets. The concomitant relatively high contact area with atmospheric oxygen results in almost complete combustion of the supplied fuel and residual gas and thus in outstanding efficiency and very low pollutant emissions. The demands on the metering device or the fuel nozzle, which meters the fuel into the combustion chamber or onto or into the ceramic foam, are very low, since the fuel is distributed within the ceramic foam.

As a result of the low thermal capacity of the ceramic foam and because the combustion process is distributed evenly throughout the entirety of the ceramic foam, the ceramic foam heats up very quickly, which means that after only a short period of operation and a potential brief interruption in the fuel supply, fuel supply resumption typically does not require external ignition, for example by means of spark plugs or the like.

A further advantage is that the ceramic foam can initially absorb a portion of the metered fuel without the fuel being ignited immediately. Instead, a portion of the fuel is distributed initially within the ceramic foam, before it is ignited on the surface of the latter. Thus, the ceramic foam is able initially to store a certain quantity of fuel. This characteristic is advantageous, for example, when the afterburner is re-started from a cold state via only inadequate remote ignition, for example from a glow filament, since the fuel cannot immediately escape unburned through the combustion chamber. Instead, it is stored in the ceramic foam and remains available for combustion. Detonations in the combustion chamber or enrichment of the fuel-air mixture beyond the point at which it will ignite are thus largely prevented.

A further significant advantage is that the fuel is distributed primarily autonomously, regardless, to a large extent, of the geometric shape of the ceramic foam. This allows great freedom in the placement of the ceramic foam in the combustion chamber or in the afterburner, in order, for example, to improve the thermal transfer from the ceramic foam to the combustion chamber or to other components of the afterburner.

In addition, the afterburner according to the present invention has an extremely wide thermal output range, as a result, in particular, of the possibility of setting very low thermal outputs. These settable, very low thermal outputs or combustive outputs make it possible to avoid pollutant-intensive start-ups and shutdowns of the afterburner that damage the material and reduce efficiency, in particular in the event of the load changes that are typical for automotive passenger transportation.

The afterburner can be advantageously refined in that the ceramic foam consists at least in part of silicon carbide. Silicon carbide has excellent resistance to heat, is an excellent heat conductor, and in addition, provides the ceramic foam with good mechanical rigidity at relatively low density. Silicon carbide is also a relatively good electrical conductor. The good electrical conductivity can be used for metering purposes, in order, for example, to determine the temperature through the electrical resistance derived from current and voltage. Alternatively, the thermal effect of the electrical current can influence or control the combustion process in particular, or, for example in the case of catalytic combustion, can perform it in its entirety, for example in partial-load operation.

It is also advantageous for the ceramic foam to be made to have open pores by means of reticulation, which may be performed either thermally or chemically. This makes it possible to achieve a high degree of porosity, and in addition, the size of the pores is able to be set very easily, for example in the range 0.05 mm to 5 mm, when the ceramic foam is manufactured.

It is advantageous for the ceramic foam to be in good heat-conducting contact with at least one part of the wall of the combustion chamber, as this means that the heat is able to be dissipated rapidly and efficiently, for example, to the reformer, a process-related component, such as a catalytic combustor, or a fuel cell.

If the ceramic foam is advantageously coated with a catalytic layer, for example, of platinum or an alloy containing platinum, the combustion process, for example, may be performed at least partially catalytically, i.e., without a flame.

If the afterburner according to the present invention also has an ignition device, the combustion process may be initiated in the afterburner at any time without significant warm-up times, and in particular following a brief interruption in fuel metering. In this process, the outside temperatures or the temperature of the afterburner are of only minor importance. The ignition device may be in the extremely simple and compact form of a glow filament or glow plug, this being advantageously located between the ceramic foam and the nozzle or in the ceramic foam itself.

A further advantageous refinement results when the nozzle is designed as a swirl nozzle, making possible an even better fuel distribution.

### BRIEF DESCRIPTION OF THE DRAWINGS

FIG. 1 shows a schematic cross-section of an exemplary embodiment of an afterburner according to the present invention.

FIG. 2 schematically shows a part of a cross-section of the open-pore ceramic foam.

### DETAILED DESCRIPTION

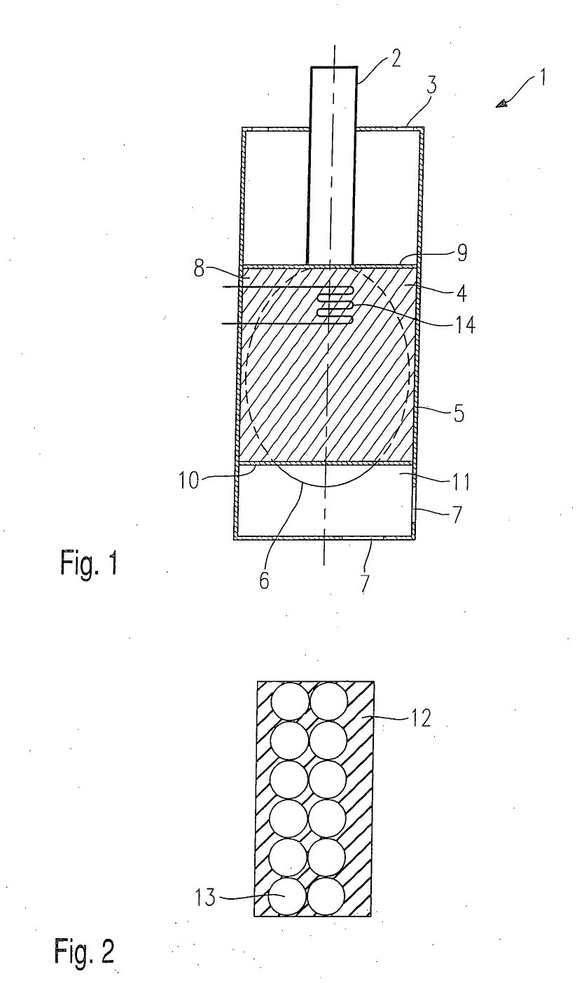

An exemplary embodiment shown in FIG. 1 of an afterburner 1 according to the present invention has a cylindrical housing 5 and a combustion chamber 8 located therein. Combustion chamber 8 is bounded on its sides by housing 5, at the top by an upper ring 9 and at the bottom by a lower ring 10 in housing 5. Upper ring 9 separates combustion chamber 8 from a nozzle 2 and lower ring 11 separates it from an outlet chamber 11. Combustion chamber 8 in this exemplary embodiment is completely filled with a ceramic foam 4. The pores of the ceramic foam are linked together both transversely and longitudinally and thus allow, in particular, excellent flow-through and almost complete combustion.

A part of a cross-section is shown schematically in FIG. 2. The pores 13 embedded in the carrier foam 12 are visible.

The ceramic foam may be made, for example, via reticulation of carrier foam 12, such as polyurethane foam, followed by treatment with a silicon carbide suspension, for example ceramic powder of silicon carbide suspended in water.

A flame area 6, starting from nozzle 2, extends in an oval shape through ceramic foam 4 located in combustion chamber 8 and ends in outlet chamber 11. Flame area 6 is only reproduced here as an example, and is dependent, for example, on the position of nozzle 2 relative to ceramic foam 4, the fuel pressure, the size of the pores in ceramic foam 4, and the characteristics of the fuel. In particular, it is possible to ensure that a flame occurs throughout entire ceramic foam 4 or, in the case of catalytic combustion, to suppress the flame completely or alternatively to permit it only in portions of ceramic foam 4.

At its axial end away from ceramic foam 4, nozzle 2 takes in fuel, residual gas, air, or a mixture thereof and meters it at its lower axial end, which faces ceramic foam 4, through an orifice, not shown, into ceramic foam 4. In addition, air is supplied via an air supply 3 to combustion chamber 8 or to the combustion process. A mixture of residual gases and air or residual gases and oxygen may also be supplied via air supply 3. Fuel, residual gas, or a mixture thereof ignites with air and/or oxygen or reacts chemically in ongoing operation on the hot surface of ceramic foam 4.

The combustion process may, however, also be initiated or maintained by ignition devices not shown in greater detail. Such ignition devices are, for example, installed between nozzle 2 and ceramic foam 4 in the form of an electric glow plug or glow filament 14. It is also possible to install the ignition device in ceramic foam 4. It may also be possible to design the ignition device in such a way that entire ceramic foam 4 or at least a portion of it is electrically heated so that the ceramic foam itself forms an ignition device. Finally, ceramic foam 4 may also be heated from the outside or through the installation and use of wires. Once the fuel and/or the residual gases have oxidized, the combustion gases escape downwards through lower ring 10 into outlet chamber 11, and then escape here through outlet orifices 7.

A large area of afterburner 1 or of housing 5 is in good heat-conducting contact with a chemical reformer, not shown, and/or a fuel cell, this contact being able to be formed so as to be interruptible.

1-10. (canceled)

11. An afterburner for afterburning a residual gas from at least one of a reforming process and a fuel cell process, comprising:
at least one nozzle to meter fuel and the residual gas into a combustion chamber;
at least one device for providing an air supply; and
a heat-resistant, open-pore ceramic foam for at least partially filling the combustion chamber.

12. The afterburner as recited in claim 11, wherein:
the afterburner is for a chemical reformer intended for procurement of hydrogen.

13. The afterburner as recited in claim 11, wherein:
the ceramic foam includes silicon carbide.

14. The afterburner as recited in claim 11, wherein:
the ceramic foam includes open pores via reticulation.

15. The afterburner as recited in claim 11, wherein:
the ceramic foam can be heated electrically.

16. The afterburner as recited in claim 11, wherein:
the ceramic foam is in good heat-conducting contact with at least one part of a wall of the combustion chamber.

17. The afterburner as recited in claim 11, further comprising:
a catalytic layer for at least partially covering the ceramic foam.

18. The afterburner as recited in claim 17, wherein:
the catalytic layer includes platinum.

19. The afterburner as recited in claim 11, further comprising:
an ignition device.

20. The afterburner as recited in claim 19, wherein:
the ignition device includes one of an electric glow filament and a glow plug.

21. The afterburner as recited in claim 19, wherein:
the ignition device is one of installed and formed one of:
between the ceramic foam and the at least one nozzle, and in the ceramic foam.

22. The afterburner as recited in claim 11, wherein:
the at least one nozzle includes one of a swirl nozzle and a multi-orifice nozzle.
